(19) United States
(12) Patent Application Publication
(10) Pub. No.: US 2024/0205853 A1
(43) Pub. Date: Jun. 20, 2024

(54) METHOD AND ARRANGEMENT FOR DETERMINING A CLOCK OFFSET BETWEEN AT LEAST TWO RADIO UNITS

(71) Applicant: KOHERENT OY, Vantaa (FI)

(72) Inventors: Kari LEPPÄNEN, Helsinki (FI); Jussi SALMI, Haarajoki (FI)

(73) Assignee: KOHERENT OY, Vantaa (FI)

(21) Appl. No.: 18/554,554

(22) PCT Filed: Apr. 19, 2022
(86) PCT No.: PCT/FI2022/050254

§ 371 Date: Oct. 9, 2023

(30) Foreign Application Priority Data
Apr. 16, 2021 (FI) 20215458

(51) Int. Cl. H04W 56/00; H04W 72/0453

(52) U.S. Cl. CPC H04W 56/0035; H04W 56/0015; H04W 72/0453

(57) ABSTRACT

A method for determining a clock offset between local clocks of at least one pair of radio units, includes performing two-way transmissions between at least one pair of radio units using signals including selected frequencies, determining phase information regarding the signals received at the radio units, determining phase differences based on the phase information, determining at least one clock offset variable, and determining an estimated maximum error in the determined clock offset variable based on maximum errors of the phase differences to determine if the maximum error of the determined clock offset variable allows the clock offset value to be unambiguously determined.

### TECHNICAL FIELD OF THE INVENTION

The invention relates to radio communication and localization in general. More specifically, the invention relates to determining a clock offset between local clocks of at least a first radio unit and a second radio unit by utilizing at least measurements of phases of received signals with respect to local oscillators of the radio units.

### BACKGROUND OF THE INVENTION

Accurate time/phase synchronization of terrestrial wireless nodes is important for many applications such as positioning and advanced wireless communication applications.

Information regarding phase and time differences between local oscillators of wireless nodes, such as radio units, may be used directly in positioning algorithms or in forcing a system to maintain a fixed time/phase relationship (cf. RTK GNSS).

The information regarding phase and time differences between local oscillators of wireless nodes may also be used in co-operative multi-point communication.

Wireless systems may utilize a backhaul of the system for the synchronization of local oscillators of wireless units. In such systems, a separate stationary reference is always required for the synchronization. Yet, the backhaul is typically based on fiber-optic technology, which may at best reach 1 nanosecond time synchronization accuracy.

Time synchronization accuracy of nanosecond time scale is not suitable for phase coherent transmission, where the required accuracy e.g. in cellular communication systems is at picosecond level. In addition, many of the prior art methods require line-of-sight between radio units to function properly. Even factors such as weather conditions could affect the accuracy of systems utilizing known methods of determining phase differences between local oscillators of radio units.

### SUMMARY OF THE INVENTION

An object of the invention is to alleviate at least some of the problems in the prior art. In accordance with one aspect of the present invention, a method is provided for determining a clock offset between local clocks of at least one pair of radio units comprising at least a first radio unit and a second radio unit, the method comprising steps of
a. performing first two-way transmissions between at least one pair of radio units using a first signal comprising a selected first frequency, wherein said transmissions are sent as broadcasts and received at at least one non-transmitting radio unit to obtain the at least one pair of radio units,
b. determining first phase information regarding the first signals received at the radio units,
c. determining a first phase difference, for each pair of radio units, as a difference between the first phase information determined for each radio unit in the pair of radio units,
d. performing second or subsequent two-way transmissions between the at least one pair of radio units using a second or subsequent signal comprising a selected second frequency or subsequent frequency,
e. determining second or subsequent phase information regarding the second or subsequent signals received at the radio units,
f. determining a second or subsequent phase difference, for each pair of radio units, as a difference between the second or subsequent phase information determined for each radio unit in the pair of radio units,
g. determining a difference between the first phase difference and the second or subsequent phase difference, or a difference between the determined phase difference at the highest or lowest signal frequency and a subsequent phase difference,
h. determining at least one clock offset variable, for each pair of radio units, being indicative of an approximated clock offset between the radio units in the pair of radio units, based on a difference determined at step g,
i. determining an estimated maximum error in the determined clock offset variable based at least on a maximum error of the first phase difference and a maximum error of the second or subsequent phase difference,
j. determining if the maximum error of the clock offset variable allows the clock offset to be unambiguously determined, by determining at least one set of possible clock offset values obtained through variation of the clock offset corresponding to variations of integer numbers of half cycle periods at at at least one of the first or subsequent frequencies, said set of possible clock offset values being limited by the estimated maximum error in the determined clock offset variable,
k. repeating the steps d-j using a subsequent selected frequency that differs from the first frequency by an amount that is more than the difference between the first frequency and the second or previously used frequency, if it is determined that the clock offset cannot be unambiguously determined.

The invention also relates to a computer program product according to independent claim 21 and an arrangement according to independent claim 20.

The invention describes a system/arrangement that can measure the mutual time synchronization and its drift at sub-picosecond-level accuracy continuously and independent of the backhaul technology.

Through the invention, clock offset and phase difference of local oscillators of radio units between two or more wireless nodes may be determined without a backhaul.

The determination of clock offset may remain essentially unaffected by slow movement of the nodes, e.g. sway in light masts due to small scale of error in the determined clock offset. In additional embodiments, the movement of one or more radio units may be taken into account and compensated for via a model and/or measurements to normalize or equalize the frame of reference for the clock offset determination measurements.

The determination of clock offset according to embodiments of the invention where a plurality of radio units are used may not be affected by whether there is a line-of-sight between the nodes or not.

The determination of clock offset according to some embodiments of the invention may be applicable even if there is no radio link at all between all the nodes/radio units (e.g. if the most distant nodes are too far apart).

The present invention may therefore provide a method of determining a clock offset between transceivers (radio units) without the need for additional transmitters or receivers in the determination of the clock offset between two or more transceivers.

The present invention may be used in terrestrial or space systems, optionally also indoors in e.g. indoor communication or positioning systems.

Accurate clock offset knowledge allows coherent processing of radio signals over distributed radio units which is necessary for phase-based positioning techniques or e.g. collaborative multi-point communication systems. Collaborative multi-point communication (CoMP) refers to a wireless communication system where multiple communication nodes transmit (or receive) in phase coherence to (from) a mobile node. Such an arrangement can be used to increase the capacity, range and reliability of wireless communication systems. This can also be referred to as multi-point MIMO. CoMP may be integrated with the present invention, such that the same radio parts and antennas that are used for determination of clock offset as is presented herein are also used for a communication service. Somewhat different frequencies or neighboring frequency bands may be utilized for the communication service than those which are used for the clock offset determination. This may avoid interference, but the frequencies may be close enough to each other that the cable phase length and clock offset information obtained via the invention would be accurate enough for coherent CoMP transmission and reception.

The present invention may allow determination or evaluation of clock offset between radio units with narrow instantaneous bandwidth of used frequencies in the transmitted signals (e.g. a bandwidth of 40 MHz or even as low as 10 kHz). The present invention provides a method and arrangement which may be inexpensive to implement, whereby inexpensive narrow band receivers may be utilized.

Due to the narrow operating bandwidth of the present invention, the system may operate at frequency bands/ranges where high transmission powers are allowed, enabling better range and accuracy than e.g. UWB-based time synchronization systems, which are required to operate at very low transmission powers. Bands that are feasible with the present invention may be e.g. 5 GHz RLAN (enabling transmission power of 100 mW or even 1 W) or WIA band (enabling transmission power of 400 mW). Therefore, the power used for transmission of one or more signals (e.g. primary and/or auxiliary signals) may be over tens of mW, such as over 20 mW, over 50 mW, or over 80 mW.

With the present invention, it may also be easy to fit the utilized narrow bands between e.g. wifi network channels.

In one embodiment, signals are transmitted by at least a portion of the radio units consecutively in a predetermined order, such that each consecutively transmitting radio unit transmits its respective signal in its own predetermined time slot.

In one embodiment, a set of possible clock offset values may be based on variation of the clock offset corresponding to variations of integer numbers of half cycle periods at the highest used frequency.

The clock offset may be determined based on at least one of the determined phase differences, optionally based on a plurality of the determined phase differences or all of the phase differences.

In an embodiment of the invention, the second (or any subsequent) frequency range may be selected based on the estimated maximum error in the determined clock offset variable so that the difference between the first and second frequency range ensures that unaccounted phase rotations are avoided, optionally by determining a possible range for the offset variable based on its maximum error and selecting the second frequency range such that the expected minimum and maximum values of the first auxiliary phase difference corresponding to the minimum and maximum values of the first clock offset variable do not differ more than a threshold value, such as 2π. Using 2π or smaller value for the threshold prevents phase ambiguity when first auxiliary (or any subsequent) phase difference is used to further limit the set of possible clock offset values.

One of the radio units, such as the first radio unit, may be selected as a reference unit, wherein the local oscillator phase of the reference unit may be set as zero.

In one embodiment, the method may comprise unambiguous determination of the clock offset at least once in an integer ambiguity mode and subsequently repeatedly sending subsequent signals, optionally in a selected frequency range, at selected time intervals, in a tracking mode to determine subsequent phase differences to repeatedly determine clock offset information being indicative of a change in clock offset between the first and second radio unit during the selected time interval.

Embodiments of the invention may thus provide an arrangement and method for continuous clock offset tracking or provision of location information, where integer ambiguity may be resolved/determined e.g. once or at predetermined intervals, while otherwise operating in a tracking mode, where signals comprised only in one narrow frequency band may be utilized, e.g. a first frequency range and only primary signals, as will be described herein. The clock offset between the radio units may be tracked without re-determination of an integer ambiguity.

In continuous clock offset tracking or tracking mode, the subsequent signals could be transmitted at predetermined adequately short time intervals such that it may be assumed that the integer ambiguity problem does not reappear, i.e. that the clock offset uncertainty between radio units between times of sending subsequent signals increases less than an amount that would lead to a cycle slip that cannot be accounted for.

In some embodiments, an estimator may be used for tracking/estimating the clock offset. The clock offset may be tracked using e.g. simple interpolator, Kalman filter, extended Kalman filter, or particle filter. The use of such estimator may make it possible to measure the phase difference (such as determined primary phase differences) with lower repetition rate (i.e. with using less and/or less frequent e.g. primary signals) without a risk of uncounted 2π phase slips in the phase difference.

The arrangement could be used for clock offset tracking such that most of the time, the transmitted signals only need to be in one narrow frequency band, e.g. a first frequency range.

One embodiment of the method may comprise obtaining or determining a preliminary clock offset variable as a first approximation of the clock offset, preferably before performing the first two-way transmissions to determine a maximum possible value for the clock offset.

An embodiment of the method may comprise at least resolving an integer ambiguity by performing the two-way transmissions in at least two frequency ranges to determine the set of clock offset values and determining the clock offset through:
sending primary signals comprising frequencies in a first frequency range, and determining at least one set of one or more possible clock offset values through:
performing two-way transmissions utilizing at least a first primary frequency and a second primary frequency,
determining at least first and second primary phase information,
determining at least first and second primary phase differences,
determining a first clock offset variable and its estimated maximum error, optionally based on the first and second primary phase differences and their maximum errors,
determining the set of possible clock offset values based on the first clock offset variable and its estimated maximum error, and
sending one or more auxiliary signals comprising frequencies in at least one second frequency range, and determining the clock offset by:
performing two-way transmissions utilizing at least a first auxiliary frequency,
determining at least first auxiliary phase information,
determining at least a first auxiliary phase difference,
determining a second clock offset variable and its estimated maximum error based on the first primary and first auxiliary phase differences and their maximum errors,
determining the clock offset based on a selected likely clock offset value, selected from the set of possible clock offset values as fitting an error margin in the second clock offset variable,
wherein the method additionally comprises determining if the likely clock offset value can be unambiguously selected from the set of possible clock offset values, and if not, sending one or more second or subsequent auxiliary signals comprising frequencies in a third or subsequent frequency range.

In one embodiment, the method may comprise sending a plurality of primary signals. The method may additionally comprise sending a plurality of auxiliary signals.

In the case of a plurality of primary or auxiliary signals, the frequency of at least consecutive primary signals and/or frequency of consecutive auxiliary signals may in an embodiment preferably be separated from each other by under 20 MHz, more preferably under 10 MHz, such as 5 MHz.

Advantageously a difference between the first frequency range and the second frequency range is at least 150 MHz, preferably at least 200 MHz, most preferably at least 500 MHz. The frequency ranges may also be in completely different radio bands: for example, the higher range could be in the 5 GHz RLAN band or in the new 6 GHz unlicensed bands whereas the lower range could be in 2.4 GHz ISM band, allowing a frequency difference over 3 GHz. Thus, the first frequency range and second frequency range could be separated by e.g. 500 MHz-5 GHz.

The first frequency range and/or the second frequency range may encompass a maximum bandwidth of 100 Hz-100 kHz, preferably 10-100 kHz in the case of only one signal transmitted in said range or 5-100 MHz, preferably 10-50 MHz, such as e.g. 40 MHz in the case of a plurality of signals being transmitted in said range.

In embodiments where only one first primary signal is used, e.g. a bandwidth of the first frequency range may be considered to essentially comprise only one frequency, still less expensive design and even coin battery operation are possible. The same applies to the second frequency range in cases where only one first auxiliary signal is utilized.

When referring to simultaneous transmissions, it should be understood that two or more signals that are to be transmitted by one radio unit are transmitted simultaneously, yet different radio units may still transmit in their own separate time slots.

A first and/or second frequency range may in some embodiments of the invention be considered as having a selected bandwidth, yet it should be understood that one or more signals in said ranges do not necessarily have to span said bandwidths, but can exhibit separate frequencies which may be comprised in said ranges.

All of the primary and/or auxiliary signals that are to be transmitted by a radio unit may be transmitted simultaneously, yet in one embodiment of the invention all signals may be transmitted consecutively, by at least one or even all of the radio units. In this embodiment, simpler and/or cheaper radio units capable of transmitting only at one frequency at a given time, that may be e.g. coin battery operated, may be utilized in an arrangement.

It is also possible to use any number of auxiliary signals in various different frequency ranges (such as third, fourth etc. frequency ranges). For simplicity, the detailed description below focuses mainly on the case where only one frequency range (the second frequency range) for auxiliary signals is used.

In one embodiment of the invention, at least a second primary signal may be sent to determine respective phase information (second primary phase information) and a second primary phase difference. The clock offset variable may be determined by comparing at least the first primary phase difference and the second primary phase difference, optionally based on a difference between the first primary phase difference and second primary phase difference. First and subsequent primary signals may be transmitted to determine respective phase information to obtain a plurality of phase differences, while the difference between phase differences (such as difference between first and each subsequent phase difference) may be used to determine a clock offset variable that is indicative of an approximate clock offset between the first and second radio unit.

A maximum error in the clock offset variable may in some embodiments be determined based on other information or may e.g. be obtained as a previously determined parameter.

The set of possible clock offset values may in one embodiment be determined based at least on the first primary phase difference, or phase difference measured at any of the used frequencies, and variation of the clock offset corresponding to integer numbers of half cycle periods at at least one of the used frequencies.

When the maximum error of the clock offset variable is known, however, this may limit the possible clock offset values to ones which are within the maximum error values of the clock offset variable. This may then be used to determine the set of possible clock offset values, which gives the possible clock offset between the radio units in terms of clock offsets that differ from each other by half a cycle period times an integer ambiguity (IA).

The second clock offset variable may correspond to a second approximate clock offset measurement between the first and second radio unit, the determining of the second clock offset variable being based on comparing at least the first primary phase difference and the first auxiliary phase difference, optionally based on a difference between the first primary phase difference and first auxiliary phase difference divided by the frequency difference of the first primary and first auxiliary signal.

A maximum error of the second clock offset variable may limit the possible clock offset values. Advantageously, when determining the second clock offset variable based on the first primary phase difference and first auxiliary phase difference, the maximum error of the second clock offset variable leaves only one possible clock offset value. The likely clock offset value may then be selected as the clock offset value from the set of possible clock offset values fitting an error margin in the second clock offset variable, said error margin being determined by the estimated maximum error in the first primary phase difference and/or the estimated maximum error in the first auxiliary phase difference.

The likely clock offset value, or the unambiguously determined clock offset value, may be or essentially correspond to the actual clock offset between the first radio unit and the second radio unit or be indicative of said offset.

A method may comprise performing two-way transmissions between a plurality of radio units and determining a plurality of clock offsets between pairs of radio units.

When employing at least three radio units and determining at least two clock offsets, clock offsets between radio nodes that have not sent and received signals among each other may also be determined using the clock offsets that may be directly determined through phase measurements. This enables determination of clock offset between radio units that are not or cannot be in communication with each other.

Additionally, when a plurality of radio units are used to determine a plurality of clock offsets via embodiments of the present invention, time and/or resources may be saved. In traditional systems with a plurality of radio nodes, a measurement is conducted in relation to each radio link, i.e. each pair of radio units separately sends a signal to each of the remaining radio units. For instance, in a system or arrangement with 10 radio units, 45 two-way signals should be utilized, whereby a total of at least 90 transmissions should be conducted. With the present invention, however, clock offsets between each of the radio units may be determined with only 10 transmissions, which may greatly reduce resources and a time duration that is required for the measurements and/or transmissions.

At least a portion of the transmitting radio units may in some embodiments transmit at least one signal within a predetermined time slot and in predetermined order. Here, the transmissions may be carried out so that transmissions occur in subsequent time slots so that no empty time slots are left between the transmissions. The transmissions and time slots may also be proportioned such that there is less than a selected “empty” time interval between the end of a transmission and the start of a subsequent time slot where a subsequent radio unit will start its transmission. A time interval between the end of a transmission and the start of a subsequent transmission may be less than 16 μs.

With embodiments of the invention where transmitting radio units transmit at least one signal within a predetermined time slot and in predetermined order, the subsequent providing of a compact transmission signal may be advantageously used in combination with e.g. WiFi networks. With the present invention, a wireless channel for the transmissions only needs to be reserved once per measurement cycle. This feature may enable compatibility of the present invention with networks such as the aforementioned WiFi.

Without transmissions occurring in predetermined time slots and predetermined order, a measurement cycle could take longer and an unknown time duration to complete. This is because one measurement cycle could not be carried out effectually as a single transmission in a wireless channel that only needs to compete for the channel once as defined e.g. in ETSI EN 301 893 (the standard specification regulating 5 GHz WiFi transmissions). The channel would have to be competed for by each transmitting antenna unit separately during transmission, which could cause arbitrarily long measurement sequences if the channel gets occupied by other users between the transmissions.

A delay in measurement sequences due to transmissions not being made effectually as a single transmission could easily lead to a situation where the channel changes more than a wavelength between the sequences (causing N*π ambiguity in the phase difference), possibly making the measurement useless. The delay could lead to an unknown change in distance between radio units between sequence, and even if the change in distance is slow, this would also mean that the local oscillators of the radio units would have to be very high in quality to maintain phase coherence between the different radio units during the longer and indeterministic measurement interval. With the present solution, however, oscillators of lower quality may be utilized in this regard, and the arrangement may be implemented at lower cost.

In one embodiment, a first radio unit may be a master unit and the remaining radio units may be slave units, the master unit being configured to transmit the first signal in a measurement cycle. The master unit may be configured to check before transmission of the first signal at each measurement cycle whether a radio channel is free for transmission and if the channel is free, at least a first signal in the measurement cycle is transmitted (such as a first primary signal), said transmitting not being executed if the channel is not free.

An arrangement may advantageously utilize radio bands/channels that require listen-before-talk functionality, as a master unit may check if the radio channel is free before transmission of a first signal and if yes, then the measurement cycle of the arrangement may be carried on with and the radio channel may then be reserved by the arrangement for at least the one measurement cycle. If it is determined that a radio channel is not free, then the first signal may not be transmitted and the measurement cycle may be aborted or cancelled without any signals being transmitted, while the master unit or first radio unit may then wait for a predetermined time between measurement cycles and then at the next measurement cycle, once more check if the radio band is free and then carry on with transmission of the first signal to initiate a measurement cycle if the radio band is free.

In some embodiments comprising a master radio unit and one or more slave radio units, the slave units may be configured to determine, before transmitting of a signal in a given measurement cycle, if a previous radio unit in the predetermined order of radio units has transmitted a signal in the measurement cycle, and if yes, transmit their respective signal, while the signal is not transmitted (waiting for a full measurement cycle) if it is determined that the previous radio unit has not transmitted a signal, i.e., if a valid measurement signal is not received. The determination whether the previous radio unit has sent its signal or not can be based e.g. on the other radio units having knowledge of the exact signal properties and being able to detect the previous transmission based on well-known correlation techniques.

One of the radio units may be set as a reference radio unit in embodiments of the invention by setting at least one phase of a received signal with respect to the local oscillator of the reference radio unit as a reference phase.

In one more embodiment of the invention, a clock rate difference between the at least first radio unit and second radio unit may be determined and said clock rate difference may be taken into account in the determining of the clock offset. A clock rate difference may be determined through sending at least a repeated (primary) signal and determining at least a repetitive (primary) phase difference, i.e. performing two-way transmissions at least twice utilizing the same frequency. The repeated e.g. primary signal may be separated from the primary signal transmission by e.g. 100 μs to 1 ms in time, but using the same frequency.

In one further embodiment of the invention, a Doppler frequency between the at least first radio unit and second radio unit may be determined, resulting from relative motion of the units, and said Doppler frequency may be taken into account in the determining of the clock offset, and the relative motion between the units may therefore be compensated for. A Doppler frequency may be determined through sending at least a repeated (primary) signal and determining at least a repeated (primary) phase difference, i.e. performing two-way transmissions at least twice utilizing the same frequency. Note that this may be estimated and taken into account independent of the aforementioned clock rate difference. The same set of measurements can be used to determine both the clock rate difference and the Doppler frequency.

In one embodiment, e.g. at least the first primary signal and the first auxiliary signal or any one of the first, second, and/or subsequent signals (sent by one radio unit) may be sent in succession.

In one other embodiment, at least for instance the first primary signal and the first auxiliary signal (or any of the transmitted signals, referring to signals transmitted by the same radio unit) may be sent at least partially simultaneously. Also a plurality of e.g. primary signals and/or a plurality of auxiliary signals may be sent simultaneously.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The previously presented considerations concerning the various embodiments of the method may be flexibly applied to the embodiments of the arrangement mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

FIG. 1 depicts one exemplary arrangement according to an embodiment of the invention,

FIG. 2 shows one more exemplary arrangement according to an embodiment of the invention,

FIG. 3 shows exemplary first and second antenna units and radio units that may be used in an arrangement,

FIG. 4 shows other exemplary first and second antenna units and radio units that may be used in an arrangement,

FIG. 5 shows, on a graph of determined phase difference as a function of transmitted signal frequency, possible determined primary phase differences, auxiliary phase differences, and lines corresponding to a set of determined clock offset values in one use case scenario according to one embodiment of the invention,

FIG. 6 illustrates one possible radio unit that may be used in an arrangement,

FIG. 7 depicts allocation of time slots in measurement cycles,

FIG. 8 portrays a flow chart of a method according to one embodiment of the invention,

FIG. 9 shows a flow chart of a method of selecting frequency ranges to be utilized in embodiments of the invention,

FIG. 10 shows a flow chart of a method according to one alternative embodiment of the invention, and

FIG. 11 illustrates, with respect to time and frequency, how signals may be transmitted in embodiments of the invention.

### DETAILED DESCRIPTION

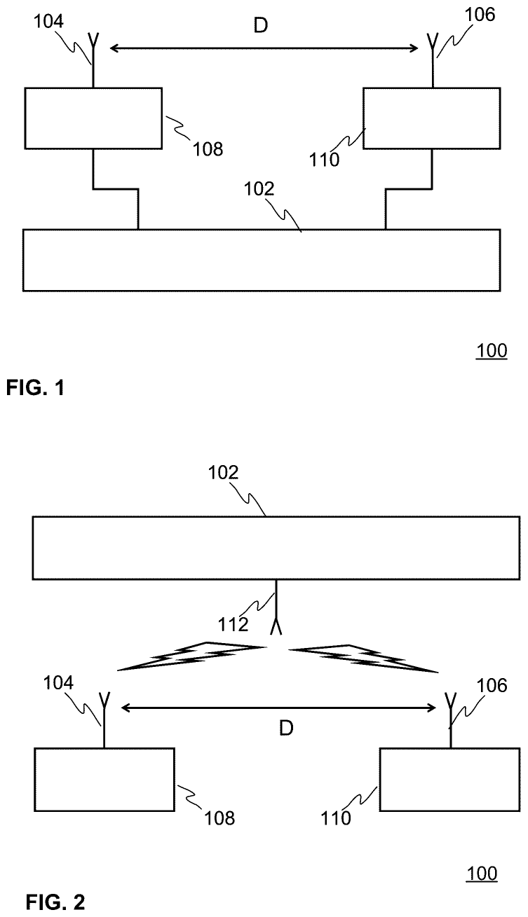

FIG. 1 shows an arrangement 100 according to one embodiment of the invention. The arrangement comprises at least a first antenna unit (AU) 104 and a second antenna unit 106, which are respectively associated with a first radio unit 108 and second radio unit 110. An antenna unit 104, 106 may be comprised in a radio unit 108, 110 or be coupled to a radio unit via e.g. cables. An arrangement 100 may also comprise some other number of antenna units and radio units, such as a third radio unit and a fourth radio unit etc. Each pair of radio units (or antenna units) that transmits and receives one or more signals among themselves may be considered to be separated by a baseline or distance D.

The radio units 108, 110 are coupled to at least one processor 102. The processor 102 may be a controller unit that is external to the radio units 108, 110, and may be implemented as a microprocessor unit or provided as a part of a larger computing unit such as a personal computer. Yet in some embodiments, the processor 102 may be comprised in or be considered to be part of a radio unit 108, 110.

The processor 102 may be configured to control the radio units and/or antenna units comprised in an arrangement 100. The processor 102 may additionally receive data from the antenna units 104, 106 or radio units 108, 110.

The processor 102 may additionally or alternatively be configured to receive data from the antenna units and/or radio units comprised in an arrangement 100 in a wired (e.g. Ethernet) or wireless (e.g. WLAN) manner. FIG. 2 shows an embodiment of an arrangement 100 where the processor 102 is wirelessly coupled to the radio units 108, 110. A processor 102 may be associated with a processor antenna unit 112.

The processor 102 and radio units 108, 110 may be powered using for instance power-over-Ethernet (PoE), direct mains supply, batteries, solar panels, or mechanical generators (e.g. in wind turbine blades).

In some embodiments, also a remote processor may be utilized in an arrangement 100, e.g. in addition to the processor 102 which may be a local processor or the processor 102 may be realized as a remote processor with no need for a local processor. A remote processor may receive any of the data obtained and could e.g. perform at least a portion of the determination of data that is carried out by the arrangement 100. A remote processor may refer to a processor which may be accessed through cloud computing or the remote processor may e.g. refer to a virtual processor comprised in a plurality of locations which may be configured to execute procedures presented herein through parallel processing means.

In the following example, the arrangement 100 and its functionality is described in connection with the first radio unit 108 and second radio unit 110, where at least a first primary signal and first auxiliary signal is transmitted by both radio units. Similar considerations apply, as will be understood by the skilled person, to any transmissions that may be sent in the method.

The first radio unit 108 is configured to send at least a first primary signal having a first primary frequency, which may be a radiofrequency (RF) signal via the first antenna unit 104. The primary signal is preferably a sine wave, but can be any signal with a known modulation. A transmitted signal may also be a sine wave with a scrambling code. The first radio unit 108 may also transmit subsequent primary signals, which will be discussed further below.

The first primary frequency (and possible subsequent primary signals) may be comprised in a first frequency range. The first frequency range may for instance encompass a maximum bandwidth of 100 Hz-100 kHz, preferably 10-100 kHz in the case of only one signal transmitted in said range or 5-100 MHz, preferably 10-50 MHz, such as e.g. 40 MHz in the case of a plurality of signals being transmitted in said range.

The duration of the first primary signal (and any subsequent signals transmitted/sent by any of the radio/antenna units of the arrangement) may for instance be between 10 and 10 000 μs depending on e.g. the length of the distances between the antenna/radio units, the time intervals between measurement cycles, and/or the quality of local oscillators comprised in the radio units 108, 110. A duration of a signal may for instance be about 100 μs.

The first primary signal is then received at the second radio unit 110 via the second antenna unit 106. Based on the received first primary signal, at least first primary phase information related to the first primary signal is determined, said first primary phase information being indicative of a phase of the received first primary signal with respect to a local oscillator of the second radio unit 110.

To be precise, typically the signal frequency is higher than the local oscillator frequency and the phase measurement often occurs in digital baseband using e.g. fast fourier transform. Essentially, this is equivalent to measuring the phase against the local oscillator that can, for simplicity, be understood to operate at the signal frequency.

If an arrangement 100 comprises further radio units such as e.g. a third radio unit, then the (first) primary signal may also be received at the third radio unit and (first) primary phase information could be determined also at the third (and subsequent) radio units. Generally, the signals may be transmitted as broadcasts, such that the at least a portion of the remaining non-transmitting radio units of the arrangement receive the signals. Pairs of radio units may comprise all possible pairs of radio units that may be considered based on the radio units of an arrangement or the pairs of radio units may comprise only a portion of the possible pairs of radio units. For instance, obstruction of the link between a possible pair of radio units may prevent a broadcast signal from reaching the other radio unit.

The second radio unit 110 is configured to transmit at least a first primary signal via the second antenna unit 106. The first primary signal may be equivalent to the first primary signal that is transmitted by the first radio unit, and essentially correspond to the first primary signal at least in frequency. The second radio unit 106 may be configured to transmit subsequent primary signals. A subsequent primary signal transmitted by the second antenna unit may essentially correspond to a subsequent primary signal transmitted by the first radio unit, etc.

The first primary signal transmitted by the second radio unit 110 is received at the first radio unit 108, via the first antenna unit 104. The transmissions between radio units in a pair of radio units are thus two-way transmissions (where a pair of radio units has thus mutually transmitted a similar signal among themselves).

Based on the received first primary signal, at least first primary phase information is determined, said first primary phase information being indicative of a phase of the received first primary signal with respect to a local oscillator of the first radio unit 108.

If an arrangement 100 comprises a plurality of radio units 108, 110, each of the radio units of the arrangement may be configured to send the e.g. first primary signal (as a broadcast after a preceding radio unit in the sequence or at least the first radio unit 108 has sent the first primary signal), which may be received at at least a portion of the other radio units of the arrangement. Corresponding phase information may be determined regarding each of the received signals. Two-way phase information may thus be determined regarding each pair of radio units and each two-way transmission.

The first primary phase information is then used to determine (by the processor 102) at least a first primary phase difference being indicative of a difference of the first primary phase information regarding the first primary signal received at the second radio unit 110 and the first primary signal received at the first radio unit 108.

The first radio unit 108 and second radio unit 100 may be configured to send subsequent primary signals, e.g. at least a second primary signal, which differs in frequency from the first primary signal. The first and subsequent primary signals are yet preferably within the first frequency range and may be transmitted simultaneously or sequentially.

The subsequent primary signal(s) may be received by the non-transmitting radio units of the arrangement, and subsequent primary phase information (e.g. at least second primary phase information) may be determined.

From subsequent primary phase information, subsequent primary phase differences, e.g. at least a second primary phase difference may be determined.

If an arrangement 100 comprises more than two radio units 108, 110, any one of them may transmit and receive the discussed signals, each one transmitting in a pre-allocated slot, one at a time, such that a clock offset between any two radio units that have among themselves sent and received at least one signal can be evaluated. Pairs of radio units that have performed two-way transmissions may be obtained, where two-way phase information is determined. From determined clock offsets based on the phase measurements, it may also be possible to determine clock offsets between a pair of radio units that have not transmitted signals between each other, if such radio units have transmitted two-way signals to one or more third radio unit(s) that is/are common to both. The clock offset can then be determined as the sum of the individual clock offset over the links connecting such two radio units.

A set of possible clock offset values is then determined based at least on the first primary phase difference, a determined first clock offset variable that is indicative of a first approximated clock offset between the antenna units, and an estimated maximum error in the determined first clock offset variable. The clock offset variable could in some embodiments be based on an approximate estimate of clock offset between the antenna units. Possible ways of determining the set of possible clock offset values will be discussed in more detail further below. A set of possible clock offset values may be determined regarding each pair of radio units.

The first radio unit 108 is also configured to send at least a first auxiliary signal having an auxiliary frequency. Except for the frequency, the first auxiliary signal may essentially correspond to the first primary signal. The first auxiliary frequency may exhibit a frequency that is in a second frequency range. The second frequency range may encompass a maximum bandwidth of 100 Hz-100 kHz, preferably 10-100 kHz in the case of only one signal transmitted in said range or 5-100 MHz, preferably 10-50 MHz, such as e.g. 40 MHz in the case of a plurality of signals being transmitted in said range.

A difference between the first frequency range (a range of the first and possible subsequent primary signals) and the second frequency range may be at least 150 MHz, preferably at least 200 MHz, most preferably at least 500 MHz. The difference could even be over 3 GHz, for example, where the two frequency ranges lie in completely different radio bands, such as the 2.4 GHz ISM, 5 GHz RLAN/ISM or 6 GHz unlicensed bands.

The frequency values of the first, second and/or any subsequent frequency range may essentially comprise any frequency values. More significant than the frequency values comprised in the frequency ranges may be a selected separation/distance or difference in frequency between the separate ranges or between the frequencies of at least the first primary signal and the first auxiliary signal.

The second antenna unit 106 receives the first auxiliary signal and first auxiliary phase information may be determined regarding the second radio unit 110, where the first auxiliary phase information is indicative of a phase of the received first auxiliary signal with respect to a local oscillator of the second radio unit 110.

The second radio unit 110 then transmits a first auxiliary signal essentially corresponding to the first auxiliary signal sent by the first radio unit 108.

The first auxiliary signal transmitted by the second antenna unit 110 is received at the first radio unit 108, and respective first auxiliary phase information is determined, where the first auxiliary phase information is indicative of a phase of the received first auxiliary signal with respect to a local oscillator of the first radio unit 108.

The first auxiliary phase information is then used to determine at least a first auxiliary phase difference being indicative of a difference of the first auxiliary phase information regarding the first auxiliary signal received at the second radio unit 110 and the first auxiliary phase information regarding the first auxiliary signal received at the first radio unit 108.

If the arrangement 100 comprises a plurality of radio units 108, 110, then each radio unit may be configured to send a signal corresponding to the first auxiliary signal, preferably consecutively and each in their own time slot. Each signal may be received by the remaining non-transmitting radio units of the arrangement (or at least a portion of the non-transmitting radio units) and corresponding first auxiliary phase information may be determined. First auxiliary phase differences may be determined in connection with each pair of radio units that has transmitted a two-way signal corresponding to the first auxiliary signal.

Processing of information may be conducted in different order than that which is proposed here. For instance, the aforementioned determination of a set of possible clock offset values may also be done e.g. after sending (and receiving) auxiliary signals. The auxiliary signal may also be sent simultaneously to the primary signal.

Subsequent auxiliary signals may also be transmitted to determine subsequent auxiliary phase information and subsequent auxiliary phase differences.

Subsequent auxiliary signals may comprise frequencies in the second frequency range.

If a plurality of auxiliary signals are transmitted, they may be transmitted simultaneously or sequentially.

Based at least on the determined first primary and first auxiliary phase differences, a likely clock offset value is determined/selected from the set of possible clock offset values (assuming that the difference between the first and second frequency range is sufficient for being able to carry out the selection unambiguously). The selection of the likely clock offset value will be discussed in more detail further below.

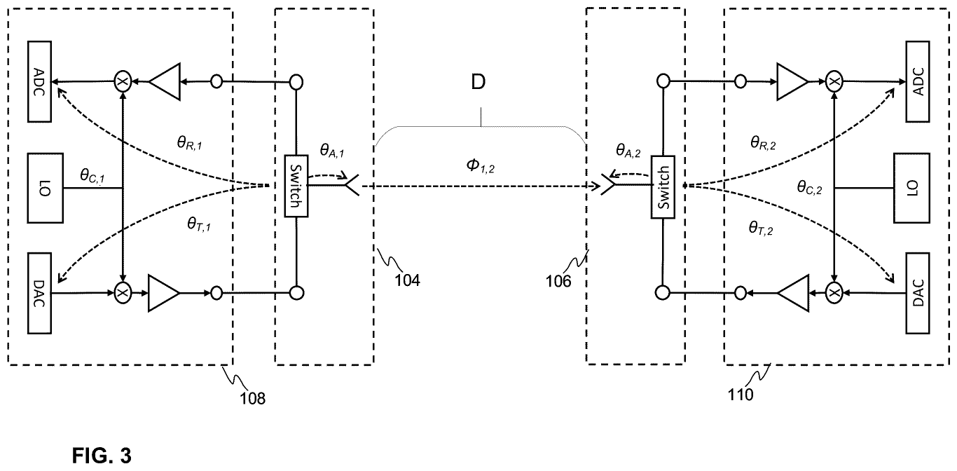

FIG. 3 illustrates exemplary first and second antenna units 104, 106 and radio units 108, 110 that may be used in an arrangement. In the example of FIG. 3, the antenna units 104, 106 are provided separately from the radio units 108, 110. FIG. 3 exhibits schematically how phase information related to signals that are transmitted and received between two antenna units 104, 106 in a pair of antenna units that mutually transmit and receive at least one signal among each other may be used to evaluate a clock offset between them.

Corresponding considerations will apply to further pairs of radio units that may be obtained in various embodiments of the arrangement.

Assuming that the transmitting first radio unit 108 transmits the at least one first primary signal with zero phase with respect to its local clock/oscillator (LO), the measured/determined phase ϕ₁₂ (or first primary phase information) of the primary signal received at the second radio unit 110 may be determined by (as also seen from FIG. 3):

φ₁₂₍ₜ₁)=Θ_{C,1}(t₁)−Θ_{T,1}−Θ_{A,1}−Φ₁₂(t₁)−Θ_{A,2}−Θ_{R,2}Θ_{C,2}(t₁) (1)

Θ_{C,1}(t₁) and Θ_{C,2}(t₁) are the phases of the local oscillators of the first and second radio units 108, 110, respectively (at the time of transmission for the first radio unit 108, t₁), which essentially translates into representing an indication of the quantity of interest, namely the clock offset. Φ₁₂(t₁) is the geometric phase corresponding to the distance or baseline or connecting geometric line D between the first antenna unit 104 and second antenna unit 106, 106. Θ_{T,1} and Θ_{R,2} are the transmit and receive branch phase lengths corresponding to the first antenna unit 104 and second antenna unit 106, respectively (with phase length referring here to the phase shift that occurs in a signal traversing along a certain distance). Θ_{A,1} and Θ_{A,2} are the phase lengths of the antenna feed cables of the first antenna unit 104 and second antenna unit 106, respectively. The phase lengths of the branches and cables can be assumed constant and therefore do not have the time dependence.

The transmit and receive branch phase lengths, e.g. Θ_{T,1} and Θ_{R,2}, comprise the phase lengths that are due to the physical lengths of the transmit and receive branches of the associated radio units, comprising e.g. amplifiers and also possible cables in the radio units. For instance, the phase length Θ_{T,1} corresponds to the length of transmission branch from the digital-analog converter (DAC) to the antenna port of the first radio unit 108.

Accordingly, the second radio unit 110 may then also transmit at least one primary signal (possibly in a pre-allocated time slot after determining that the corresponding signal from the first radio unit 108 has been transmitted), and the first primary signal may be received at at least the first radio unit 108.

Yet, assuming that the second radio unit 110 transmits the first primary signal with zero phase with respect to its local clock/oscillator (LO), the measured/determined phase φ₂₁ (or first primary phase information) of the primary signal received at the first radio unit 108 may be determined by:

φ₂₁₍ₜ₂₎=Θ_{C,2}(t₂)−Θ_{T,2}−Θ_{A,1}−Φ₂₁−Θ_{A,2}−Θ_{R,1}−Θ_{C,1}(t₂). (2)

Θ_{C,2}(t₂) and Θ_{C,1}(t₂) are the phases of the local oscillators of the second and first radio units 110, 108, respectively (at the time of transmission for the second radio unit 110, t₂). Φ₂₁(t₂) is the geometric phase corresponding to the distance or baseline or connecting geometric line between the second antenna unit 106 and the first antenna unit 104. Θ_{T,2} and Θ_{R1} are the transmit and receive branch phase lengths corresponding to the first antenna unit 104 and second antenna unit 106, respectively.

The radio units may send the determined phase information (and possibly also other information, such as amplitude information) to a processor 102 (which may e.g. be incorporated with one of the radio units). The processor 102 may then determine at least a first primary phase difference.

A phase difference may be determined as a difference of the phase information relating to a signal that has been sent by one radio unit and received at one other radio unit and a corresponding signal that has been sent by the one other radio unit (e.g. second radio unit 110) and received at the one radio unit (e.g. first radio unit 108). In the example of FIG. 3 with a first 108 and second radio unit 110, a phase difference (e.g. first primary phase difference) Φ_{d} may be determined as:

Φ_{d}=φ₁₂−φ₂₁=Θ_{C,1}(t₁)−Θ_{T,1}Θ_{A,1}Φ₁₂₍ₜ₁)Θ_{A,2}Θ_{R,2}Θ_{C,2(t1)}−[Θ_{C,2(t2)}−Θ_{T,2}−Θ_{A,1}−Φ₂₁₍ₜ₂₎−Θ_{A,2}−Θ_{R,1}−Θ_{C,1(t2)}]=[Θ_{C,1(t1)}−Θ_{C,2(t1)}]+[Θ_{C,1(t2)}−Θ_{C,2(t2)}]+[Φ₂₁₍ₜ₂₎−Φ₁₂₍ₜ₁₎]+(Θ_{T,2}+Θ_{A,1}+Θ_{A,2}+Θ_{R,1})−(Θ_{T,1}+Θ_{A,1}+Θ_{A,2}+Θ_{R,2}) (3)
where the time dependence of p has been omitted for clarity. The term (Θ_{T,2}+Θ_{A,1}+Θ_{A,2}+Θ_{R,1})−(Θ_{T,1}+Θ_{A,1}+Θ_{A,2}+Θ_{R,2}) can be considered either to cancel out (in case of identical radio nodes and antennas) or can be accounted for by well-known tx/rx rf chain calibration methods. With this assumption,

Φ_{d}=2(̅Θ̅_̅{̅C̅,̅1̅}̅−̅Θ̅_̅{̅C̅,̅2̅}̅)̅+[Φ₂₁(t₂)−Φ₁₂(t₁)] (4)
where (̅Θ̅_̅{̅C̅,̅1̅}̅−̅Θ̅_̅{̅C̅,̅2̅}̅)̅ is the average local oscillator phase difference between t₁ and t₂.

With high quality oscillators the drift rate dΘ_{C}/dt, or the frequency offset between the local oscillators of the first radio unit 108 and second radio unit 110, remains practically constant and we can write,

$${ϕ}_{d} = 2 {ΔΘ}_{C} ( {t}_{1} ) + \frac{d {Θ}_{C}}{dt} ( {t}_{2} - {t}_{1} ) \qquad ( 5 )$$

where we have marked ΔΘ_{C}(t₁)=Θ_{C,1}(t₁)−Θ_{C,2}(t₁) and used Φ₁₂(t)=Φ₂₁(t)=Φ(t). If the radio channel is constant (i.e. the distance between the first and second radio unit does not change and objects contributing to reflections do not move with reference to the radio units), the Doppler frequency do/dt is zero. This is a reasonable assumption for e.g. fixed radio base stations or positioning nodes in most cases. However, if this assumption cannot be made, dΦ/dt can be determined as will be discussed later.

From equation (5) LO phase difference at time t₁ may be obtained as

$${ΔΘ}_{C} ( {t}_{1} ) = \frac{1}{2} [ {ϕ}_{d} - \frac{d {Θ}_{C}}{dt} ( {t}_{2} - {t}_{1} ) ] \qquad ( 6 )$$

If the frequency offset dΘ_{C}/dt is not known, the LO phase difference at a time instant exactly halfway between t₁ and t₂ can still be determined as

$${ΔΘ}_{C} ( {t}_{1} + \frac{{t}_{2} - {t}_{1}}{2} ) = \frac{1}{2} {Φ}_{d} \qquad ( 7 )$$

Possible frequency offset between local oscillators of radio units 108 and 110, which allows transforming the clock offset epoch to any time near t₁ where the linear phase drift holds, can be determined as will be discussed later. One can select one of the radio nodes, such as the first radio unit, as a reference clock (or reference station/unit) by assigning Θ_{C,ref}=0, and a system of equations can be formed to solve the remaining unknown local oscillator phase offsets Θ_{C} from the differences ΔΘ_{C}.

The relation between LO phase offset Θ_{C} and clock offset T must follow the simple relation

Θ_{C}=2π·τ·f+Θᵢₙₛₜ(f) (8)
which allows the LO phase offset to be calculated from the clock offset τ if the instrumental term Θᵢₙₛₜ(f) is known. In the following analysis Θᵢₙₛₜ(f) is assumed to be zero to simplify the equations. In practice, its value can be assumed reasonably constant at a given frequency f and can be measured with suitable instrumentation. From (7) and (8),and recognizing that the measured phase difference Φ_{d} can only obtain values in the range [−π, π] it follows

$$τ = \frac{{Θ}_{C}}{2 π f} = \frac{{Φ}_{d} + N * 4 π}{4 π f} \qquad ( 9 )$$

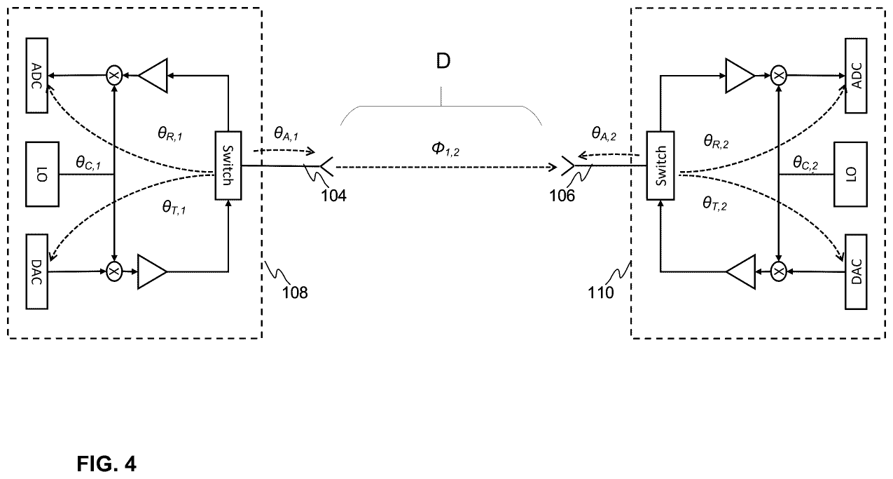

FIG. 4 exhibits other exemplary first and second antenna units 104 and 106 and radio units 108 and 110 that may be used in an arrangement 100. In this embodiment, the antenna units 104, 106 are comprised in the radio units 108, 110, or advantageously connected only with a single antenna cable. In this text, the radio units are considered to comprise the antenna units irrespective of whether the antenna units are implemented as part of the radio unit body or not.

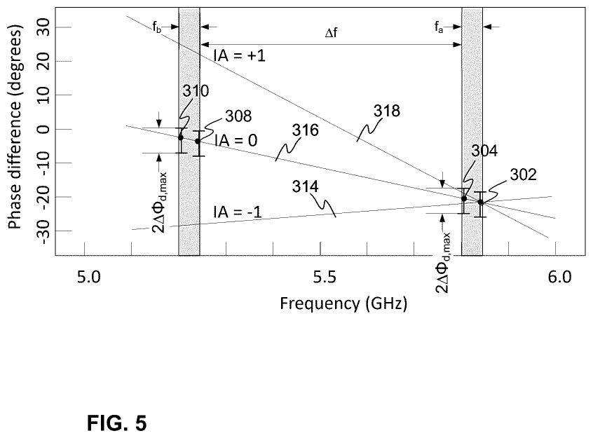

FIG. 5 shows, on a graph of determined phase difference as a function of transmitted signal frequency, possible determined primary phase differences, auxiliary phase differences, and lines corresponding to a set of possible clock offset values in one use case scenario according to one embodiment of the invention. The e.g. numbers, lines, and calculated values of FIG. 5 are merely exemplary and are intended as visual aids in describing the invention. The exact depicted values might be possible e.g. in a case where the clock difference is only about 200 picoseconds. However, the principle remains the same for any clock difference.

Depicted points 302 and 304 may correspond to a first primary phase difference and second primary phase difference, respectively. In this example, first and second primary signals (having frequencies of f₁ and f₂) have therefore been transmitted. The primary signals are in a first frequency range fₐ. The exemplary first frequency range fₐ spans a frequency range of about 40 MHz. E.g. the number of transmitted signals and the frequencies that the first frequency range fₐ spans, along with the width of the first band (range of spanned frequencies) may of course differ between use cases.

The primary signals may be sent in one transmission (regarding one radio unit transmitting in its respective time slot) where a plurality of e.g. sine waves may be transmitted simultaneously. The difference in frequency between consecutive signals may be e.g. between 1 and 40 MHz, between 5 and 20 MHz, such as about 10 MHz.

Points 308 and 310 may correspond to a first auxiliary phase difference and second auxiliary phase difference respectively. In this example, first and second auxiliary signals (with frequencies of f₃ and f₄) have therefore been transmitted. The auxiliary signals are in a second frequency range f_{b}. The exemplary second frequency range f_{b} spans a frequency range of about 40 MHz. Again, the number of transmitted signals and the frequencies that the second frequency range f_{b} spans (which could be e.g. only one frequency), and the width of the second band may also differ.

First and second frequency ranges fₐ, f_{b} may be equivalent in bandwidth or the bandwidths may differ from each other. Yet, the first and second frequency ranges are advantageously both narrow enough to enable the use of narrow band receivers (cf. WiFi receivers) or even Internet-of-Things receivers operating on a coin battery.

The difference Δf between the first frequency range fₐ and second frequency range f_{b} is about 550 MHz in the example of FIG. 5. The frequencies of the primary signals can be larger than the frequencies of the auxiliary signals or the frequencies of the primary signals can be smaller than the frequencies of the auxiliary signals, yet there is advantageously a difference Δf between the frequencies/frequency ranges that is sufficiently large that a likely clock offset value can be determined.

In some embodiments of the invention, signals may be transmitted also in third and possibly fourth and subsequent narrow bands in addition to the first band or first frequency range fₐ and second band or second frequency range f_{b}.

The number of frequency ranges that should preferably be utilized in order to be able to determine or select a likely clock offset value from the set of determined possible clock offset values may vary depending on the environment, use case or embodiment.

When at least two signals, e.g. a first primary signal and second primary signal having carrier frequencies f₁ and f₂ are utilized, the clock offset variable indicative of the clock offset between the first and second radio units may be expressed as a difference between respective phase differences (difference between a first (primary) phase difference and second (primary) phase difference):

ϕτ₁=(Φ_{d,f1}−Φ_{d,f2}+N·4π)/[4π(f₁−f₂)] (10)

This can be understood from the relation between clock offset and the measured phase difference given by equation (9). The maximum error in clock offset variable is

Δτₘₐₓ=2ΔΦ_{d,max}/[4π(f₁−f₂)] (11)
where ΔΦ_{d,max} is the maximum error in a single phase difference measurement and with the assumption that N is known, in other words f₁-f₂ is selected to be suitably small to avoid phase ambiguity. Such ambiguity can be avoided if |Φ_{d,f1}−Φ_{d,f2}|<2π in equation (10), and hence

Δfₘₐₓ|f₁−f₂|ₘₐₓ<1/(2Δτₘₐₓ) (12)

The inaccuracy of the clock offset determined through equation (11) may, however, be relatively high due to measurement error or estimated possible is error ΔΦ_{d} in measurements of phase differences Φ_{d,f1} and Φ_{d,f2}. Typically, the phase measurement error is caused by thermal or phase noise in the radio receiver. With high-quality oscillators, thermal noise dominates. As thermal noise has well known statistical properties, the typical and maximum error in phase differences is easy to estimate from the known system noise and signal levels.

Through an estimated maximum error value ΔΦ_{d,max}, limits for any errors in values determined using the determined phase information may be determined. An estimate for a maximum error ΔΦ_{d,max} may be sufficient for the procedure described herein to be feasible. In what follows, ΔΦ_{d,max} should be understood as the maximum value that the phase measurement error can take.

The maximum measurement error ΔΦ_{d,max} may be determined for a specific use case or arrangement 100. The maximum measurement error may be known a priori or may be received by an arrangement 100. For instance, the maximum measurement error ΔΦ_{d,max} may be determined based on a known phase measurement/determination accuracy of the arrangement 100.

ΔΦ_{d,max} may be a value that is selected such that it is known that a true error in phase measurements will likely always be below this value.

It should be noted that using a value ΔΦ_{d,max} that is too large does not in any way make the following procedure invalid. Too small a value, however, can lead to unaccounted for phase rotations between the frequency ranges and can lead to incorrect clock offset determination. Therefore, ΔΦ_{d,max} should preferably be selected conservatively.

For instance, if f₁ and f₂ differ from each other by 40 MHz and considering a measurement error ΔΦ_{d,max} of 10 degrees, the maximum error in the determined clock offset variable Δτₘₐₓ may be about 700 picoseconds. This may be seen from equation (11).

A determined approximate clock offset between the at least one pair of radio units comprising at least the first radio unit and second radio unit may in some embodiments alternatively (instead of through phase measurements such as described above) be obtained e.g. through previous knowledge or a measured approximate clock offset (measured e.g. using an electrical or optical method). This approximate clock offset may be used as the clock offset variable as a preliminary clock offset variable that may be used to determine a preliminary set of possible clock offset values. A maximum error for an e.g. otherwise measured approximate (preliminary) clock offset (variable) may then also be determined or obtained.

A preliminary clock offset variable may be used as a first approximation of the clock offset and may be determined before performing any of the transmissions to determine a maximum possible value for the clock offset.

If a preliminary clock offset variable is obtained, it could be possible that a first and second signal (or a first primary signal and first auxiliary signal) are sufficient for unambiguously determining the clock offset value.

In addition to error arising from the measurement error ΔΦ_{d,max}, there may also be an ambiguity of 2π in the determined ΔΦ_{d,1} but this would already mean an ambiguity of about 13 nanoseconds considering the above example scenario (from equation (10)). In this case, if there is preliminary information regarding the clock offset that is more accurate than the 13 nanoseconds, the 2π inaccuracy could be eliminated.

This problem of 2π uncertainty may also be reduced by transmitting consecutive primary signals that differ in frequency by less than a threshold value. The consecutive primary signals (such as f₁ and f₂) may e.g. be separated by under 20 MHz, under 15 MHz, or e.g. by 10 MHz or 5 MHz or under. In the case of 5 MHz signal frequency difference (difference between e.g. f₁ and f₂), a 2π ambiguity in the clock offset determined through equation (10) would be about 100 nanoseconds. Upon having a priori knowledge about the clock offset that has accuracy better than 100 nanoseconds, the 2π uncertainty can be eliminated in this particular case. Such an accuracy is achievable e.g. with a synchronization sequence utilizing a full instantaneous 40 MHz bandwidth. Yet, it is advantageous to have the transmitted primary signals cover a frequency range that in total spans e.g. at least 40 MHz in order to limit the inaccuracy of the clock offset variable determination.

Upon considering that the clock offset T must be the difference of N+IA (integer ambiguity) half cycle periods T₁ at the primary frequency and a fractional component τ_{frac} (always smaller than quarter of a period in magnitude), equation (10) may be utilized to determine the integer ambiguity through:

τ=(N+IA)*(T₁/2)+τ_{frac}=(Φ_{d,f1}−Φ_{d,f2})/[4π(f₁−f₂)], (13)
where T₁ is the period of the first primary signal and Φ_{d} is given in radians.

The possible values of N+IA correspond to those which satisfy equation (13), taking into account the maximum error in the measurement of (Φ_{d,f1}−Φ_{d,f2}) which is 2ΔΦ_{d,max}. ΔΦ_{d,max} therefore defines a range which integer ambiguity values IA or N+IA may take, giving a set of possible integer ambiguity values.

The set of possible integer ambiguity values corresponds to or defines a set of possible clock offset values τ if τ_{frac} can be determined.

N, which is the best estimate of the number of half cycle periods between the clocks, can be derived as the closest match to equation (13) by setting IA=0.

The possible range of IA (−ΔIA<IA<AIA) is limited by this maximum phase estimation error ΔΦ_{d,max} as follows (as can be derived from the previous equation):

$$Δ IA = \frac{{ΔΦ}_{d , max}}{π ( 1 - \frac{{f}_{2}}{{f}_{1}} )} . \qquad ( 14 )$$

By setting f₂ (and correspondingly also Φ_{d,f2}) in equation (13) to zero and noting that Φ_{d,f1} must correspond to the fractional component of τ_{frac}, it follows that the phase difference fulfills the following equation:

Φ_{d,f1}=4π·f₁·τ+(N+IA)·2π (15)

This assumes that the instrumental phase errors that cannot be canceled out with the basic measurement, (Θ_{T,2}+Θ_{A,1}+Θ_{A,2}+Θ_{R,1})−(Θ_{T,1}+Θ_{A,1}+Θ_{A,2}+Θ_{R,2}) in equation (3) and ιᵢₙₛₜ in equation (8)) of the arrangement are zero (or determined separately and eliminated from the calculation). From this, the clock offset may be determined as

$$τ = \frac{{Φ}_{d , f 1} - ( N + IA ) \cdot 2 π}{4 π \cdot {f}_{1}} , \qquad ( 16 )$$

from which τ may be determined with higher accuracy than from equation (10), because f₁ is much larger in magnitude than f₁−f₂.

The problem with equation (16) is then the integer ambiguity (not knowing the value of N+IA, or, if N is determined from equation 13, the value of IA). For example, with a signal frequency f₁ of 6 GHz, the ambiguity in T is IA*83 picoseconds. Equation (16) may however be used to determine the set of possible clock offset values and the likely clock offset value may be determined, based on the obtained phase information, approximate clock offset, and estimated maximum errors therein.

Yet, as given before, through determining the phase difference Φ_{d,f1}−Φ_{d,f2}, the clock offset may be known roughly to an accuracy of ±700 picoseconds if f₁ and f₂ are separated by 40 MHz and if the maximum measurement error ΔΦ_{d,max} in the phase differences is 10 degrees. For f₁=5.8 GHz with a half cycle period of 86 picoseconds, the integer ambiguity is limited to about 16 different possible values (a set of determined possible integer ambiguity values).

The set of possible integer ambiguity values may be graphically understood to correspond to integer ambiguity lines, when considering phase difference as a function of transmission frequency, where the integer ambiguity lines have slopes determined by the clock offset given by equation (16) (with a scaling factor of 4π). This is illustrated in FIG. 5. The set of possible IA values or set of possible clock offset values are shown as integer ambiguity lines that cross the first primary phase difference 302. The line corresponding to slope determined from (13) with IA=0 (the best preliminary match), which also determines the value for N, is shown as 316. The neighboring possibilities are IA=+1 (318) and IA=−1 (314), corresponding to clock offset differences of half a cycle period larger or smaller, respectively. All of these fit the error margins of 2ΔΦ_{d,max} around the primary phase difference measurements shown as error bars and are therefore part of the set of possible IA values or possible clock offset values.

In terms of a determined first clock offset variable when considering a first and second primary signal, the error margins to be considered upon determining the set of possible clock offset values may be limited by the maximum error in the phase differences and the frequency difference between the first and second primary signals, as may be understood from equation (10). The maximum error of the first clock offset variable may thus be given by 2δₘₐₓ/[4 π(f₁−f₂)], which may be used to give the error margins for the first clock offset variable, which limit the set of possible clock offset values.

In embodiments where subsequent primary or auxiliary phase differences are determined, the integer ambiguity line IA=0 may be determined as the line that crosses two of the determined primary phase differences or a line that has the best least-squares fit to the primary phase difference points.

In the case of utilizing more than two primary signals, the first clock offset variable may be determined as a least-squares fit and to determine the maximum error for the first clock offset variable, one may for instance use statistical estimation methods to derive the boundaries for the first clock offset variable for given probability values. If more than two primary signals are utilized, the discussed first primary signal and second primary signal should be understood as referring to the primary signals that are spaced furthest apart in frequency, with third and possible subsequent primary signals having frequencies between the first primary signal and second primary signal.

Upon transmission of at least one auxiliary signal, preferably where the auxiliary signal frequency f₃ differs from f₁ or f₂ by at least e.g. 400 MHz, at least a first auxiliary phase difference Φ_{d},f₃ may then be determined. With a determined second phase difference Φ_{d},f₁−Φ_{d},f₃ and f₁−f₃ and utilizing equation (10), a second, better approximation of clock offset variable Δτ₂ may be determined, in which the inaccuracy may be e.g. ±70 picoseconds instead of the ±700 picoseconds for the first approximation obtained from equation (10) using Φ_{d,f1}−Φ_{d,f2} and f₁−f₂. It should be noted that the values are here estimated for the considered frequencies and may vary between use cases. Numerical values are given here to illustrate differences in error magnitudes of determined approximate clock offset variables.

Through equation (10), but utilizing the first primary phase difference and the first auxiliary phase difference to obtain a second phase difference Φ_{d},f₁−Φ_{d},f₃, a second clock offset variable Δτ₂ being indicative of a second approximate clock offset may be determined as:

Δτ₂=(Φ_{d,f1}−Φ_{d,f3})/[4π(f₁−f₃)] (17)

Using the estimated maximum error in the first primary phase difference ΔΦ_{d,max} and/or an estimated maximum error in the first auxiliary phase difference, which may also be e.g. ΔΦ_{d,max}, an estimated maximum error for Φ_{d,f1}−Φ_{d,f} may be obtained (possibly amounting to 2ΔΦ_{d,max}). This may give also a maximum error for the second clock offset variable.

The second clock offset variable Δτ₂ may be used to determine possible clock offset values for the clock offset which correspond to clock offset variations of integer numbers of half cycle periods at one of the used frequencies, such as the first primary frequency. The maximum error of the second clock offset variable may give error limits in which the likely clock offset value should fit.

Through the above, there may only be one possible clock offset value or, in other words, only one possible value of IA left, giving the likely IA value or likely clock offset value, and the integer ambiguity may thereby be resolved.

Through the determined likely integer ambiguity value IA, the clock offset T may be calculated/determined using equation (16), and the clock offset between the first radio unit 108 and the second radio unit 110 may be determined to an accuracy of e.g. under a few picoseconds.

If it is observed that the likely clock offset values are not limited to one possible clock offset value, a third frequency range may be selected that differs from the second frequency range by a selected frequency difference and auxiliary signals may be transmitted in the third frequency range to further limit the set of possible clock offset values.

In FIG. 5, it is seen that the likely integer ambiguity value is one which corresponds to an integer ambiguity line that fits the measurement error ΔΦ_{d,max}, which in this example would be IA=0, corresponding to line 316.

In cases where a plurality of primary and/or auxiliary phase differences are determined, e.g. least squares fitting or some other fitting technique may be used to determine integer ambiguity lines or possible clock offset values, through slopes of integer ambiguity lines, that are fit taking into account preferably all of the measured phase differences.

In one embodiment, an arrangement 100 may be configured to perform the above discussed integer ambiguity determination protocol at least once and thereafter operate in a tracking mode, where the arrangement 100 may be configured to track the clock offset between the first and second radio unit 108 and 110 by repeatedly sending subsequent primary signals (in an e.g. first frequency range, spanning a narrow range of frequencies fₐ), determining subsequent primary phases, and determining primary phase differences to repeatedly determine clock offset information being indicative of a change in clock offset between the first and second radio unit. By summing up such clock offset changes the true clock offset can be continuously tracked in this mode.

After the integer ambiguity has been determined at least once, it may be assumed (e.g. based on a known or approximated change in clock offset between the first radio unit 108 and the second radio unit 110) that the integer ambiguity does not change between subsequent measurements in the tracking mode. An integer ambiguity could also be determined e.g. between predetermined time intervals to ensure that the integer ambiguity value determined previously is still valid, i.e. no phase slips have occurred.

The tracking mode is advantageously used in clock offset tracking as only one narrow frequency band (e.g. a first frequency range fₐ comprising primary signals) may be required for transmission of signals during regular operation. Transmissions in a different (narrow) frequency range (e.g. second frequency range f_{b}) may only be needed once before transitioning into the tracking mode or at predetermined time intervals which may still be only rare compared to the signals transmitted in the tracking mode. For example, the phase tracking (through transmission of (primary) signals in a first narrow band) could be repeated between time intervals ranging between for instance 0.1 and 50 ms or 1 and 20 ms, e.g. every 10 ms. A new IA determination (through additional transmission of at least one (auxiliary) signal in a second narrow band) could be only done between time intervals ranging between for instance 0.1 s and 10 s s or 0.5 s and 5 s, e.g. once per second.

The procedure to be followed in embodiments of the present invention may also be described without consideration of the frequency ranges as disclosed above. The transmitted signals may be considered as at least a first signal with a first frequency and second signal with a second frequency, followed by subsequent signals with subsequent frequencies, e.g. a third signal with a third frequency.

Based on two-way transmissions and determined phase information, first and second or subsequent phase differences may be determined, along with a difference between the first phase difference and the second or subsequent phase difference.

At least one clock offset variable may then be determined, based on a difference between the first phase difference and the second or subsequent phase difference. A maximum error in the determined clock offset variable may also be determined based at least on a maximum error of the first phase difference and a maximum error of the second or subsequent phase difference.

At least one set of possible clock offset values may be determined through variation of the clock offset corresponding to variations of integer numbers of half cycle periods at at least one of the used frequencies, such as first primary frequency (or any of the used frequencies), said set of possible clock offset values being limited by the estimated maximum error in the determined clock offset variable.

The variation of the clock offset may be e.g. carried out utilizing variations of integer numbers of half cycle periods at the highest used frequency. In this case, if the clock offset can be determined unambiguously at the highest frequency, it is known that the clock offset can be unambiguously determined utilizing also the lower frequencies.

The two-way transmissions at subsequent selected frequencies may be repeated to determine clock offset variables and associated maximum errors and sets of possible clock offset values until there is only one possible clock offset value left, and the clock offset can thus be unambiguously determined.

A frequency for a subsequent frequency may be selected such that the subsequent frequency differs from the first frequency by an amount that is more than the difference between the first frequency and the second or previously used frequency.

The final, unambiguous, clock offset value may be determined through equation (16) using any of the determined phase differences. Optionally, the final clock offset value may be determined using more than one or all of the phase differences. One other possible way to determine the final clock offset value may be to determine the clock offset value (using equation 16) for a plurality or each of the determined phase differences separately, and then determine the final clock offset value as an (optionally weighted) average of them. Another option is to find a value for the clock offset that yields the best least squares fit to the phase differences determined utilizing the different frequencies. It should be understood that computing such least squares fit can also be performed in a complex domain instead of using the real phase values.

Of course, the above procedure may also be considered to comprise the selected frequencies in at least a first and second frequency range. In the embodiments of the present invention described herein, the frequency ranges are not necessarily selected beforehand, as the clock offset value may be determined by selecting second and subsequent frequencies to ultimately span a total frequency range encompassing the first and second frequency range, or at least the considered primary and auxiliary frequencies.

The clock offset variables to be determined in connection with any of the performed second or subsequent (or any further primary or auxiliary) transmissions (or at least after optionally obtaining a preliminary clock offset variable) may be obtained using equation (10). The frequency f₂ may be substituted with the transmission frequency used at each step or cycle and f₁ may be substituted with a highest or lowest used signal frequency.

In still another embodiment of the invention, frequency offsets between the local oscillators and/or a possible Doppler frequency between the antenna units can be determined and compensated for in the determination of clock offset. After at least sending first primary signals and determining first primary phase information, at least repeated primary signals comprising the first primary frequency are sent to determine repetitive primary phase information regarding a signal received at the second radio unit

φ₁₂(t₃)=Θ_{C,1}(t₃)−Θ_{T,1}−Θ_{A,1}−Φ₁₂(t₃)−Θ_{A,2}−Θ_{R,2}−Θ_{C,2}(t₃) (18)
and repetitive primary phase information regarding a signal received at the first radio unit

φ₂₁(t₄)=Θ_{C,2}(t₄)−Θ_{T,2}−Θ_{A,1}−Φ₂₁(t₄)−Θ_{A,2}−Θ_{R,1}−Θ_{C,1}(t₄) (19)

Making the first radio node the reference station, we can write Θ_{C,1}(t)=0. Let us assume that the time between the signal sent by the first and second radio unit is kept constant, that is t₃-t₁=t₄-t₂=Δt. Also the instrumental terms can be assumed constant. With these assumptions and noting that Φ₁₂(t)=Φ₂₁(t)=Φ(t), a repetitive primary phase difference regarding a signal received at the second radio unit may be given as

$${φ}_{12} ( {t}_{3} ) - {φ}_{12} ( {t}_{1} ) = - \frac{d Φ}{dt} \cdot Δ t - \frac{d {Θ}_{C , 2}}{dt} \cdot Δ t \qquad ( 20 )$$

and a repetitive primary phase difference regarding a signal received at the first radio unit as

$${φ}_{21} ( {t}_{4} ) - {φ}_{21} ( {t}_{2} ) = - \frac{d Φ}{dt} \cdot Δ t - \frac{d {Θ}_{C , 2}}{dt} \cdot Δ t \qquad ( 21 )$$

Both the Doppler dΦ/dt and the LO frequency offset dΘ_{C,2}/dt can be solved from these two equations and compensated for in equation (5). Note that this solution is also possible even if the interval between the signals vary, as long as the intervals are known.

The additional phase measurements with a repeated primary signal can be made either in each full measurement cycle or intermittently. For the frequency offset and/or Doppler frequency determination, the utilized signals may also be other signals, such as repeated auxiliary signal. The utilized signals may also be e.g. the same signals that are used in the determination of the set of possible clock offset values such as explained above with reference to FIG. 5.

In one embodiment, the described phase difference measurements may be used as an input to e.g. a Kalman estimator to track the Doppler and LO frequency offsets, removing the requirement of them being constant.

Considerations regarding Doppler and LO frequency offsets apply also to first, second, and subsequent signals transmitted without explicit selection of the first and second frequency ranges (and associated signals termed primary and auxiliary).

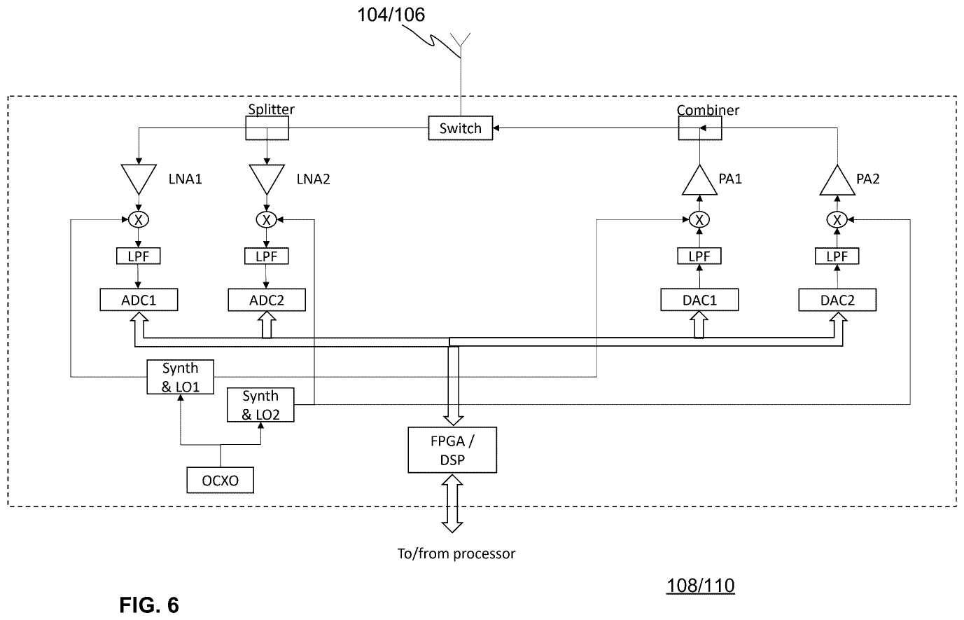

FIG. 6 shows one possible embodiment of a radio unit 108, 110 that may be used in an arrangement 100, where an antenna unit 104, 106 is comprised in the radio unit 108, 110. The radio unit 108, 110 of FIG. 6 comprises two receivers and transmitters, the frequency of which can be set separately.

Utilizing a radio unit 108, 110 with a plurality of receivers, simultaneous measurement of multiple bands, such as a first band comprising primary frequencies and at least a second band comprising auxiliary frequencies may be possible. At least a portion of primary signals that are to be transmitted and at least a portion of auxiliary signals that are to be transmitted can be transmitted at least partially simultaneously.

In some embodiments, a radio unit 108, 110 may comprise more than two receivers, and more than two primary or auxiliary signals may be transmitted (and received) simultaneously. In addition to a first band comprising primary frequencies a second band comprising auxiliary frequencies, e.g. a third band comprising further auxiliary frequencies could be transmitted and received at least partially simultaneously.

In still another embodiment, the primary and auxiliary signals in a plurality of frequency ranges can be sent in a succession (only one signal at a time). Such a system could operate with extremely narrow bandwidth (e.g. 100 Hz-100 kHz) and use extremely low-cost hardware and small batteries.

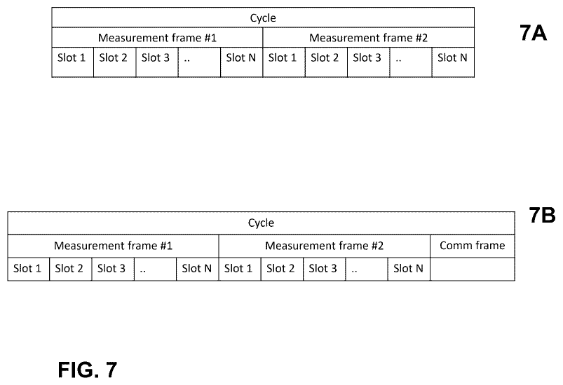

FIGS. 7A and 7B illustrate how time slots may be allocated in measurement cycles for transmission and receiving of signals and possibly also communication of data in an arrangement 100. A measurement cycle may refer to a set of transmitted signals or a time duration within which signals are sent one after another such that the time between subsequent transmissions is below a threshold value. For instance, a first measurement cycle could comprise the transmission (and receiving) of primary signals and auxiliary signals. In some embodiments, a second measurement cycle may be carried out. The second measurement cycle could e.g. be equivalent to the first measurement cycle or a second measurement cycle could e.g. comprise only transmission (and receiving) of primary signals in embodiments where a tracking mode is utilized.

One measurement cycle may comprise at least one measurement frame (with N measurement slots). During the measurement frame, the at least first radio unit 108 and second radio unit 110 may transmit their respective signals separately, each in their own time slot which is allocated to them. One measurement frame may comprise the transmission of signals having one frequency. For example, primary signals could be transmitted in a first measurement frame, while auxiliary signals are transmitted in a second measurement frame. The measurement cycle of FIG. 7A is applicable to an arrangement 100 comprising N radio units, where the clock offset between each radio unit may be evaluated. Each radio unit may transmit their respective signals in their own time slot.

In embodiments where at least a repeated primary signal is transmitted, a measurement cycle may comprise at least three measurement frames, where primary signals are sent in the first measurement frame, repeated primary signals are sent in the second measurement frame, and auxiliary signals are sent in the first and second measurement frames, simultaneously to the primary signals. Here, the determination of LO frequency difference(s) and/or Doppler frequency (or frequencies) may also be carried out. Alternatively, a third measurement frame could be used for sending the auxiliary signals, depending on the hardware capability, i.e. if the simultaneous transmission of primary and auxiliary signals is not feasible.

Transmissions may be carried out so that transmissions occur in subsequent time slots so that no empty time slots are left between the transmissions. The transmissions and time slots may also be proportioned such that there is a time interval between the end of a transmission and the start of a subsequent time slot where a subsequent antenna unit will start its transmission is below a selected maximum time interval. A time interval between the end of a transmission and the start of a subsequent transmission may be less than less than 50 μs, preferably less than 20 μs, such as less than 16 μs.

The subsequent provision of a compact transmission signal may be advantageously used in combination with e.g. WiFi networks. With the present invention, a wireless channel for the transmissions only needs to be reserved once per measurement cycle. This feature may enable compatibility of the present invention with networks such as WiFi.

Without transmissions occurring in subsequent time slots, a measurement cycle could take longer and an unknown time duration to complete. This is because one measurement cycle could not be carried out effectually as a single transmission in a wireless channel that only needs to compete for the channel once as defined e.g. in ETSI EN 301 893 (the standard specification regulating 5 GHz WiFi transmissions). The channel would have to be competed for by each transmitting radio unit separately during transmission, which could cause arbitrarily long measurement sequences if the channel gets occupied by other users between the transmissions.

FIG. 7B shows how time slots may be allocated in measurement cycles where at least one communication frame (with one or more communication slots) is also employed. During a communication frame, signals, measured/determined data, or any other data may be transmitted to a processor 102. At least one data communication may be transmitted and multiplexed with the measurement signals transmitted by the radio units in time or frequency domain. The at least one data communication may comprise at least the determined phase information. A data communication may additionally or alternatively comprise any other information. An arrangement 100 may thus serve as a measurement arrangement and a communication network simultaneously.

The required time synchronization accuracy should preferably be better than a quarter of the duration of a possible guard time between subsequent signals) in order to prevent overlapping transmissions. Note that this requirement is much more relaxed than the clock offset estimation accuracy and reaching such coarse synchronization is easily accomplished e.g. with a synchronization sequence.

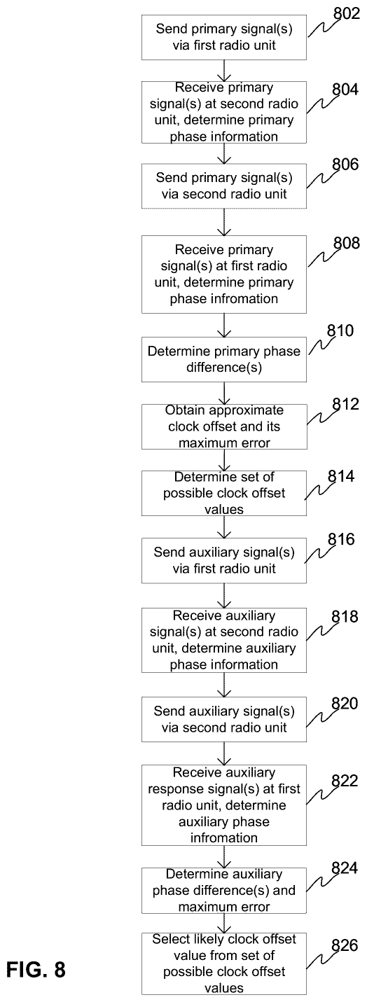

FIG. 8 illustrates a flow chart of a method according to one embodiment of the invention. At least one primary signal with a frequency in a first frequency range fₐ is sent 802 via a first radio unit 108, which is received 804 at a second radio unit 110, through which primary phase information is determined.

At least one primary signal is then sent 806 by the second radio unit110, which is received 808 at the first radio unit 108, through which respective primary phase information is determined.

Based on the determined phase information, at least one primary phase difference is determined 810. An approximate clock offset between the first and second radio unit and a maximum error in the approximate clock offset may be obtained at 812, while a set of possible clock offset values being indicative of the clock offset between the radio units is determined 814, preferably being based at least on the approximate clock offset and its error and the first primary phase difference.

At least one auxiliary signal with a frequency in a second frequency range f_{b} is then sent 816 via the first radio unit 108, which is received 818 at a second radio unit 110, through which auxiliary phase information is determined.

At least one auxiliary signal is then sent 820 by the second radio unit 110, which is received 822 at the first radio unit 108, through which auxiliary phase information is determined.

Based on the determined auxiliary phase information, at least a first auxiliary phase difference and its maximum error is determined 824.

At 826, the likely clock offset value is selected from the set of possible clock offset values preferably based at least on the first primary phase difference, first auxiliary phase difference, and the maximum error in the first primary and/or auxiliary phase differences.

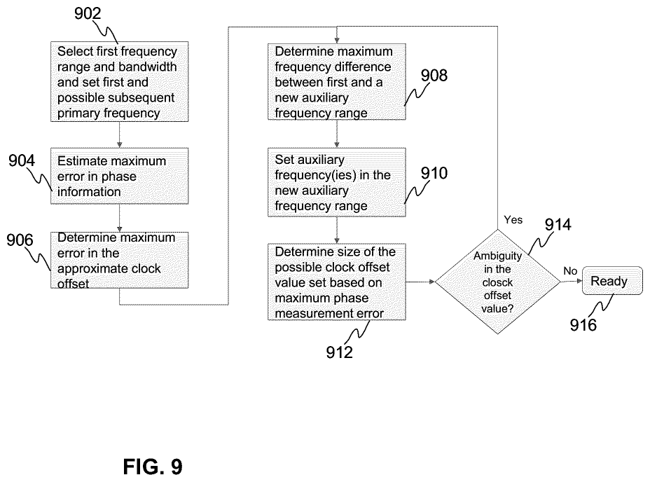

FIG. 9 shows a flow chart of a method of selecting frequency ranges to be utilized in embodiments of the invention. A first frequency range fₐ is selected 902, with a first bandwidth. At least a first primary frequency is then set, while possible second and subsequent primary frequencies may also be set.

A maximum error in the phase information that is determined may be estimated or obtained at 904.

At 906 a maximum error in a determined or obtained approximate clock offset between the first and second radio unit is determined. The maximum error in the approximate clock offset may be based on maximum errors in phase differences (if at least two primary frequencies are used), being based on the determined maximum error in phase information at step 904. Alternatively, any other means to determine the maximum error in the approximate clock offset may be used, e.g. a maximum error in another measurement method that may be used to determine the approximate clock offset.

A maximum frequency difference Δfₘₐₓ between the first frequency range fₐ and the second frequency range f_{b} may be determined 908, such that unaccounted phase rotations are avoided. It may be advantageous to set the frequency difference Δf as large as possible, i.e. to the maximum value Δfₘₐₓ to reduce the set of possible clock offset values most efficiently, preferably to be able to unambiguously select the likely clock offset value from the set of possible clock offset values.

The first frequency range fₐ may comprise frequencies that are larger than those comprised in the second frequency range f_{b} or vice versa.

In determining the maximum frequency difference Δfₘₐₓ, to ensure that unaccounted phase rotations, i.e. phase slips of 2π do not occur, minimum and maximum possible values of at least the first clock offset variable (or approximated clock offset) could in one embodiment be used to determine a possible range for at least the first clock offset variable. If an obtained range for the first clock offset variable Δτ₁ is between [Δτ_{1,min}, Δτ_{1,max}] (range between the minimum and maximum values for Δτ₁) and a determined primary phase difference at a first primary frequency f₁ is Φ₁, then it is known that a first auxiliary frequency f₃ should be in a range limited by expected minimum and maximum values of the first auxiliary phases differences and determined by [Φ₃ₘᵢₙ,Φ₃ₘₐₓ]=Φ₁+(f₁-f₃)*phase slope range=Φ₁+(f₁-f₃)*4π*[Δτ_{1,min}, Δτ_{1,max}], where Φ₃ is the first auxiliary phase difference and the phase slope range refers to a range of possible slopes for integer ambiguity lines, which could also be expressed in terms of an error in clock offset values. If the difference between the expected minimum and maximum values of the at least first auxiliary phase difference, |Φ₃ₘₐₓ−Φ₃ₘᵢₙ|, is larger than 2π, then the first primary frequency f₃ is too far from the first primary frequency f₁, in other words, the frequency difference exceeds a maximum frequency difference Δfₘₐₓ which is the largest value that still realizes this condition. The difference between the expected minimum and maximum values of the at least first auxiliary phase difference Φ₃ could be selected to be under a threshold value, such as 2π. This may give a possible range for the at least one first auxiliary frequency f₃, giving a possible second frequency range f_{b}, which differs from the first frequency range fₐ by Δfₘₐₓ at most.

A second frequency range f_{b} may then be determined and at least a first auxiliary frequency may be set 910. After determining at least a first auxiliary phase difference and its error, the size of the set of possible clock offset values may be determined 912. Advantageously, the set has only one possible clock offset value left, which can be determined as the likely clock offset value. Yet, if at 914 it is determined that there is ambiguity in the clock offset value, i.e. the size of the set of possible clock offset values is larger than 1, the process may be continued at 908, and a maximum frequency difference Δf_{max,2} between the second frequency range f_{b} or the first frequency range fₐ and new, third frequency range may be determined. Signals in the third frequency range may be set and subsequent phase information may be determined to determine a new, third set of possible clock offset values.

Selection of a new auxiliary frequency range may be carried out any number of times, if it is determined that there is ambiguity in the clock offset value, i.e. the likely clock offset value cannot be selected uniquely. The process is ended 916 when there is only one possible clock offset value left, this being the likely clock offset value from which the clock offset between the first and second radio unit may be determined with an accuracy that is higher than the approximate clock offset variable.

The procedure of FIG. 9 may also be followed in terms of considering consecutive signals with selected frequencies, without explicit selection of the frequency ranges. Here, the selecting of a first frequency at 902 may be followed by determining and setting 908, 910 a frequency for the second or subsequent signal. A clock offset variable may be determined 906 and maximum error may be determined 904, followed by determining 912 the size of the set of possible clock offset values. After determining if ambiguity is left 914, a frequency for a subsequent signal may be determined 908, 910 if such ambiguity remains.

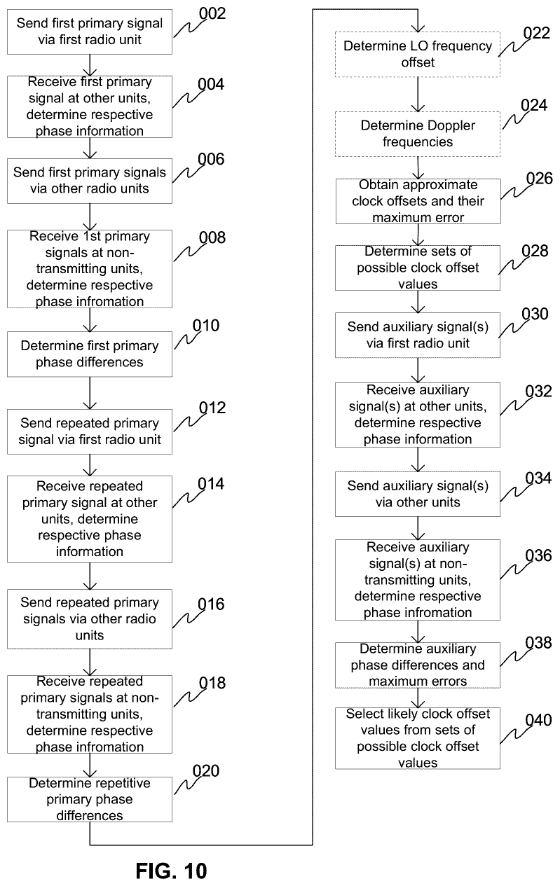

FIG. 10 shows one more flow chart of a method according to an embodiment of the present invention. In this embodiment, a plurality of radio units and at least first and repeated primary signals are employed. A first primary signal (in a first frequency range) may be sent 002 via a first radio unit 104. The first radio unit 104 may be a master unit that may also be configured to check if a channel is free for transmission before sending any signals.

The first radio unit 104 (or any other radio unit of an arrangement that participates in the transmissions) may be selected as a reference unit.

At 004, the first primary signal may be received at at least a portion of the remaining non-transmitting radio units of the arrangement. Respective phase information relating to the received signal regarding the phase of the signal with respect to a local oscillator of each receiving radio unit may then be determined. Phase information may be determined correspondingly as explained in the previously disclosed case of two radio units.

First primary signals may then be sent 006 via at least a portion of the radio units that have not sent the first primary signal. At 006, the first primary signals may be transmitted by each radio unit one at a time, sequentially, and in predetermined order and in a predetermined time slot.

At 008, the first primary signals may be received at the non-transmitting radio units and respective phase information may be determined. Therefore, measurements may be carried out such that a plurality of radio units has sent at least one similar signal (here the first primary signals) and has received a plurality of signals, each being transmitted by one other radio unit (two-way transmissions). A plurality of pairs of radio units that have sent and received at least one signal among one another may be obtained.

First primary phase differences may be determined 010, where the phase differences may be essentially determined as disclosed previously, but at least first primary phase differences may be determined corresponding to each of the pairs of radio units.

At least a repeated primary signal may advantageously be sent 012 via the first radio unit 104 and received 014 at the non-transmitting radio units, whereby respective phase information may be determined. At least a plurality of repeated primary signals may be sent 016 by the remaining radio units sequentially, preferably in predetermined order and time slot. The repeated primary signals may be received 018 at the non-transmitting radio units and respective phase information may be determined. A plurality of pairs of radio units may thereby be obtained, where the radio units in each pair have sent and received among themselves a signal corresponding to the repeated primary signal.

Repetitive primary phase differences may then be determined 020.

At 022, LO frequency offset may optionally be determined corresponding to a frequency offset between local oscillators of at least one of the pairs of radio units. The LO frequency offset may be determined for a portion of the pairs of radio units or all of them.

A Doppler frequency may in some embodiments optionally be determined 024 for at least one (or a portion or all) of the pairs of radio units.

At 026, an approximate clock offset regarding each pair of radio units may be obtained or determined. Maximum errors in the approximate clock offsets may then be obtained or estimated to determine 0268 a plurality of sets of possible clock offset values, such that a set of possible clock offset values is determined for each pair of radio units. The maximum error may be determined based on a maximum error of the determined phase differences, which may be determined based on a maximum error of phase information or phase measurement(s).

At least a first auxiliary signal (in a second frequency range) may be sent 030 by the first radio unit 104. At 032, the first auxiliary signal may be received by the non-transmitting radio units, and respective phase information may be determined.

At least first auxiliary signals may be sent 034 by the remaining radio units sequentially and preferably in predetermined order and time slot. The first auxiliary signals may be received at the non-transmitting radio units and respective phase information may be determined at 0336 to obtain pairs of radio units that have sent and received at least among themselves a signal corresponding to the first auxiliary (response) signal.

At 038, at least first auxiliary phase differences may be determined.

The steps at 030-038 may be repeated for second, third, etc. auxiliary signals and second, third, etc. auxiliary signals. Accordingly, also the steps corresponding to those at 002-010 and/or 012-020 may be repeated for further (such as third) primary signals.

Likely clock offset values may then be selected 040 from the sets of possible clock offset values, such that a likely clock offset value is preferably determined for each pair of radio units. The selecting of likely clock offset values may be carried out with respect to the pairs of radio units according to the procedure set forth before with respect to two radio units.

If the likely clock offset values cannot be determined unambiguously, a third frequency range may be selected for further transmission of auxiliary signals in a third frequency range, as has been disclosed hereinbefore.

The obtaining of approximate clock offset values, maximum errors in approximate clock offset values and maximum error in phase differences, determination of sets of clock offset values, and selection of likely clock offset values may be carried out for embodiments of the invention utilizing a plurality of radio units in a similar fashion to that disclosed herein for the case of two radio units, as may be appreciated by the skilled person.

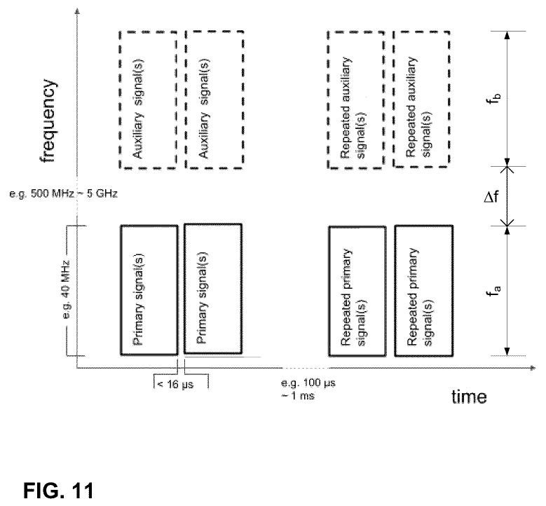

FIG. 11 shows how signals may be transmitted in embodiments of the invention. The horizontal axis represents time while the vertical axis represents frequency. Here, primary signal(s) and auxiliary signal(s) may be transmitted essentially simultaneously (referring to transmission by one radio unit), where the primary signal(s) are comprised in a first frequency range fₐ and auxiliary signals are comprised in a second frequency range f_{b}, where the frequency ranges may be separated by Δf.

Repeated primary signal(s) (if utilized) and optional repeated auxiliary signal(s) may be transmitted at times which differ from the times where the primary signal(s) and auxiliary signal(s) are transmitted, preferably such that said time difference is longer that the time difference between sending of a signal by one radio unit and a corresponding signal by another radio unit.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. A method for determining a clock offset between local clocks of at least one pair of radio units comprising at least a first radio unit and a second radio unit, the method comprising steps of
a. performing first two-way transmissions between at least one pair of radio units using a first signal comprising a selected first frequency, wherein said transmissions are sent as broadcasts and received at at least one non-transmitting radio unit to obtain the at least one pair of radio units,
b. determining first phase information regarding the first signals received at the radio units,
c. determining a first phase difference, for each pair of radio units, as a difference between the first phase information determined for each radio unit in the pair of radio units,
d. performing second or subsequent two-way transmissions between the at least one pair of radio units using a second or subsequent signal comprising a selected second frequency or subsequent frequency,
e. determining second or subsequent phase information regarding the second or subsequent signals received at the radio units,
f. determining a second or subsequent phase difference, for each pair of radio units, as a difference between the second or subsequent phase information determined for each radio unit in the pair of radio units,
g. determining a difference between the first phase difference and the second or subsequent phase difference, or a difference between the determined phase difference at the highest or lowest signal frequency and a subsequent phase difference,
h. determining at least one clock offset variable, for each pair of radio units, being indicative of an approximated clock offset between the radio units in the pair of radio units, based on a difference determined at step g,
i. determining an estimated maximum error in the determined clock offset variable based at least on a maximum error of the first phase difference and a maximum error of the second or subsequent phase difference,
j. determining if the maximum error of the clock offset variable allows the clock offset to be unambiguously determined, by determining a set of possible clock offset values obtained through variation of the clock offset corresponding to variations of integer numbers of half cycle periods at the first or subsequent frequency, said set of possible clock offset values being limited by the estimated maximum error in the determined clock offset variable,
k. repeating the steps d-j using a subsequent selected frequency that differs from the first frequency by an amount that is more than the difference between the first frequency and the second or previously used frequency, if it is determined that the clock offset cannot be unambiguously determined.

2. The method of claim 1, wherein signals by at least a portion of different radio units are transmitted consecutively in a predetermined order, such that each consecutively transmitting radio unit transmits its respective signal in its own predetermined time slot.

3. The method of claim 1, wherein a set of possible clock offset values is based on variation of the clock offset corresponding to variations of integer numbers of half cycle periods at the highest used frequency.

4. The method of claim 1, wherein the clock offset is determined based on at least one of the determined phase differences, optionally based on a plurality of the determined phase differences or all of the phase differences.

5. The method of claim 1, wherein the method additionally comprises selecting a frequency for the second or subsequent signals by determining a possible range for the clock offset variable based on its maximum error and selecting the second or subsequent frequency such that expected minimum and maximum values of the second or subsequent phase difference corresponding to the minimum and maximum values of the clock offset variable do not differ more than a threshold value of 2π.

6. The method of claim 1, wherein the method comprises performing two-way transmissions between a plurality of radio units and determining a plurality of clock offsets between pairs of radio units.

7. The method of claim 1, wherein one of the radio units is selected as a reference unit, preferably wherein the local oscillator phase of the reference unit is set as zero.

8. The method of claim 1, wherein the method comprises unambiguous determination of the clock offset at least once in an integer ambiguity mode and subsequently repeatedly sending subsequent signals, optionally in a selected frequency range, at selected time intervals in a tracking mode to determine subsequent phase differences to repeatedly determine clock offset information being indicative of a change in clock offset between the first and second radio unit during the selected time interval.

9. The method of claim 1, wherein the method comprises obtaining or determining a preliminary clock offset variable as a first approximation of the clock offset, preferably before performing the first two-way transmissions to determine a maximum possible value for the clock offset.

10. The method of claim 1, the method comprising at least resolving an integer ambiguity by performing the two-way transmissions in at least two frequency ranges to determine the set of clock offset values and determining the clock offset through:
sending primary signals comprising frequencies in a first frequency range, and determining at least one set of one or more possible clock offset values through:
performing two-way transmissions utilizing at least a first primary frequency and a second primary frequency,
determining at least first and second primary phase information,
determining at least first and second primary phase differences,
determining a first clock offset variable and its estimated maximum error, optionally based on the first and second primary phase differences and their maximum errors,
determining the set of possible clock offset values based on the first clock offset variable and its estimated maximum error, and
sending one or more auxiliary signals comprising frequencies in at least one second frequency range, and determining the clock offset by:
performing two-way transmissions utilizing at least a first auxiliary frequency,
determining at least first auxiliary phase information,
determining at least a first auxiliary phase difference,
determining a second clock offset variable and its estimated maximum error based on the first primary and first auxiliary phase differences and their maximum errors,
determining the clock offset based on a selected likely clock offset value, selected from the set of possible clock offset values as fitting an error margin in the second clock offset variable,
wherein the method additionally comprises determining if the likely clock offset value can be unambiguously selected from the set of possible clock offset values, and if not, sending one or more second or subsequent auxiliary signals comprising frequencies in a third or subsequent frequency range.

11. The method of any of claim 10, wherein the method comprises sending a plurality of primary signals, preferably wherein the method additionally comprises sending a plurality of auxiliary signals, further wherein preferably the frequency of at least consecutive primary signals and/or frequency of possible consecutive auxiliary signals are separated from each other by under 20 MHz, more preferably under 10 MHz.

12. The method of claim 10, wherein a difference between the first frequency range and the second or subsequent frequency range is at least 150 MHz, preferably at least 200 MHz, most preferably at least 500 MHz.

13. The method of claim 10, wherein the first frequency range and/or the second frequency range encompasses a maximum bandwidth of 100 Hz-100 kHz, preferably 10-100 kHz in the case of only one signal sent in said range or 5-100 MHz, preferably 10-50 MHz in the case of a plurality of signals being sent in said range.

14. The method of claim 1, wherein the method comprises sending at least two signals by one radio unit at least partially simultaneously.

15. The method of claim 1, wherein the first radio unit is a master unit and the remaining radio units, comprising at least the second radio unit, are slave units, the master unit being configured to transmit the first signal, wherein the master unit is configured to check before transmission of the first signal at each measurement cycle whether a radio channel is free for transmission and if the channel is free, the at least first signal is transmitted, said transmitting not being executed if the channel is not free, further wherein the slave units are preferably configured to determine, before transmitting of a signal in a given measurement cycle, if a previous radio unit in a predetermined order of radio units has transmitted a signal in the measurement cycle, and if yes, transmit their respective signal.

16. The method of claim 1, wherein the method comprises determining a clock rate difference between the at least first radio unit and second radio unit and accounting for said clock rate difference in the determining of the clock offset.

17. The method of claim 1, additionally comprising determining a Doppler frequency resulting from relative motion between the at least first radio unit and second radio unit, and taking said Doppler frequency into account in the determining of the clock offset.

18. The method of claim 1, wherein the method comprises transmission of signals in one or more time slots in a measurement frame and transmission of data in one or more time slots in a communication frame.

19. The method of claim 1, wherein the signals comprise a sine wave, optionally a sine wave with a scrambling code.

20. An arrangement for determining clock offset between at least a first and second radio unit, the arrangement comprising at least a first radio unit, a second radio unit, and at least one processor, the arrangement being configured to:
a. perform first two-way transmissions between at least one pair of radio units using a first signal comprising a selected first frequency, wherein said transmissions are sent as broadcasts and received at at least one non-transmitting radio unit to obtain the at least one pair of radio units,
b. determine first phase information regarding the first signals received at the radio units,
c. determine a first phase difference, for each pair of radio units, as a difference between the first phase information determined for each radio unit in the pair of radio units,
d. perform second or subsequent two-way transmissions between the at least one pair of radio units using a second or subsequent signal comprising a selected second frequency or subsequent frequency,
e. determine second or subsequent phase information regarding the second or subsequent signals received at the radio units,
f. determine a second or subsequent phase difference, for each pair of radio units, as a difference between the second or subsequent phase information determined for each radio unit in the pair of radio units,
g. determine a difference between the first phase difference and the second or subsequent phase difference, or a difference between the determined phase difference at the highest or lowest signal frequency and a subsequent phase difference,
h. determine at least one clock offset variable, for each pair of radio units, being indicative of an approximated clock offset between the radio units in the pair of radio units, based on a difference determined at step g,
i. determine an estimated maximum error in the determined clock offset variable based at least on a maximum error of the first phase difference and a maximum error of the second or subsequent phase difference,
j. determine if the maximum error of the clock offset variable allows the clock offset to be unambiguously determined, by determining a set of a set of possible clock offset values obtained through variation of the clock offset corresponding to variations of integer numbers of half cycle periods at the first or subsequent frequency, said set of possible clock offset values being limited by the estimated maximum error in the determined clock offset variable,
k. repeat the steps d-j using a subsequent selected frequency that differs from the first frequency by an amount that is more than the difference between the first frequency and the second or previously used frequency, if it is determined that the clock offset cannot be unambiguously determined.

21. A computer program product comprising non-transitory computer program code means configure to execute the method of claim 1 when run on a processor.
